(19) United States
(12) Patent Application Publication
(10) Pub. No.: US 2002/0144863 A1
(43) Pub. Date: Oct. 10, 2002

(54) Drive sump oil pan system with integrated reservoir and oil filter

(75) Inventor: Jeff Powell, Belle River (CA)

Correspondence Address: Elsa Keller, SIEMENS CORPORATION, 186 Wood Avenue South, Iselln, NJ, 08830, US

(73) Assignee: Siemens Canada Limited

(21) Appl. No.: 09/826,672

(22) Filed: Apr. 5, 2001

Related U.S. Application Data
(60) Provisional application No. 60/241,500, filed on Oct. 18, 2000.

(51) Int. Cl. F16C 3/14

(52) U.S. Cl. 184/1.5

(57) ABSTRACT

An improved dry sump oil system includes a removable oil reservoir. An oil filter is integrated into the oil reservoir and acts to filter the oil being delivered through a supply line to the engine. Preferably, an electric oil pump is mounted within the supply line. The oil reservoir is removable as a unit, such that the oil can be easily recycled.

### BACKGROUND OF THE INVENTION

This invention claims priority to Provisional Patent Application Serial No. 60/241,500, filed Oct. 18, 2000.

Vehicles have historically been provided with so-called “wet sump” engine oil supply systems. In a wet sump system, an oil pan provides the bottom of an oil sump in the engine, and maintains a quantity of oil even when the engine is shut down. While these systems have enjoyed wide acceptance, there are some packaging drawbacks.

In particular, the use of the large sump beneath the engine requires a larger vertical package for the engine.

Thus, it has been proposed to utilize so-called dry sump engines. With a dry sump, the engine is packaged within a much smaller vertical envelope. A dry sump typically stores the oil in a remote reservoir, and pumps the oil to the engine.

While dry sump systems have been proposed in the past, it would be desirable to provide a more practical and beneficial dry sump system.

One problem with all oil systems is the disposal of used oil. The handling of the used oil presents a potential environmental hazard. Thus, it has been difficult to transport used oil to recycling facilities or otherwise dispose of the used oil.

### SUMMARY OF THE INVENTION

In the disclosed embodiment of this invention, a dry sump oiling system is provided with a removable reservoir. The removable reservoir can be easily removed for changing the oil, and all of the oil will be captured within the reservoir.

In preferred embodiments, an oil filter is incorporated within the reservoir such that when the reservoir is changed the oil filter will be removed with the reservoir. Thus, recycling or disposal of the oil is simplified compared to the prior art.

In a preferred embodiment the removable reservoir is mounted within a mount structure, and has valves which selectively close an inlet and outlet on the reservoir. When the reservoir is removed from its mount location, the valves close the ports, ensuring that there will be no leakage. However, when the reservoir is mounted within the system, pins from associated ports move the valves to an open position such that oil can flow into and out of the reservoir.

In a further feature of this invention an electric motor is associated with the supply port, such that oil is drawn through the supply port and sent to the engine. The use of the electric motor allows the oil pump to start up when the engine ignition is initially started. This ensures an adequate supply of oil to the engine at an early point. Typically, engine oil pumps are driven by the engine, and thus do not always deliver adequate oil at initial startup.

These and other features of the present invention can be best understood from the following specification and drawings, the following of which is a brief description.

### BRIEF DESCRIPTION OF THE DRAWINGS

FIG. 1 schematically shows the engine oil system.

FIG. 2 shows the inventive oil reservoir.

### DETAILED DESCRIPTION OF A PREFERRED EMBODIMENT

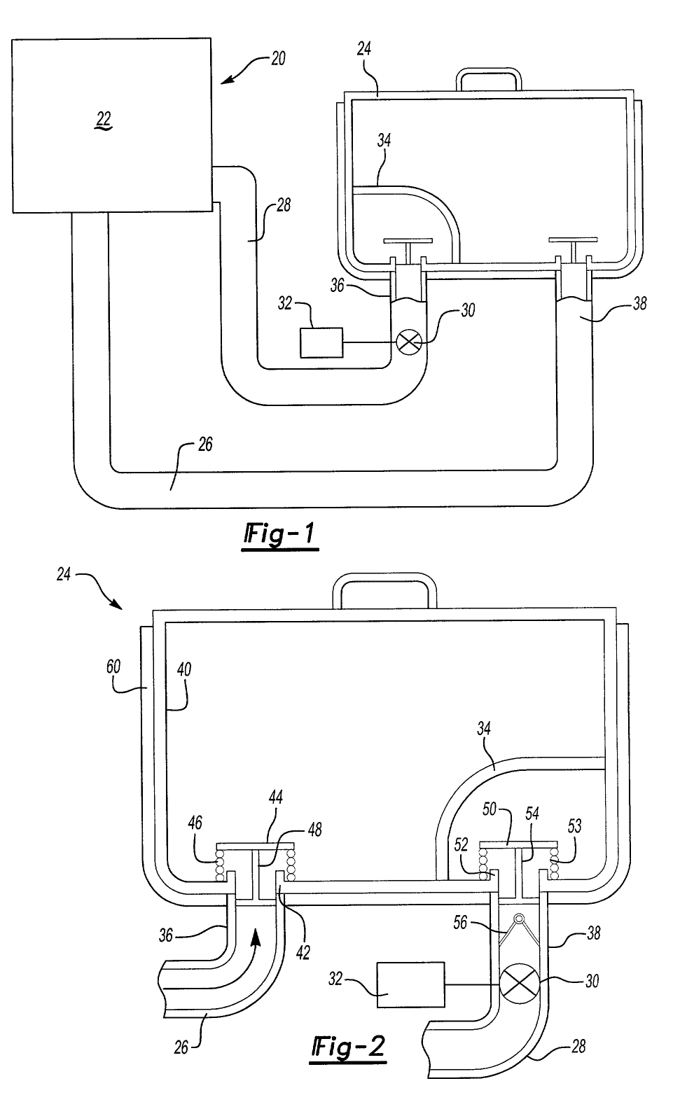

An engine oil system 20 is illustrated in FIG. 1 having an engine 22 and an oil reservoir 24. The oil reservoir 24 and engine 22 in combination provide a “dry sump” at the engine 22. Thus, the engine may have a vertically smaller envelope than the typical vehicle engine. An oil return line 26 leads from the engine 22 back to the reservoir 24. An oil supply line 28 delivers oil from the reservoir 24 to the engine 22 when a pump 30 is being driven by an electric motor 32. The electric motor 32 and pump 30 are preferably easily removed from the passage 28 for replacement or repair. Since the pump 30 utilizes an electric motor 32, the motor 32 is started when the engine is initially started. In this way, oil is delivered to the engine at startup of the engine. As is known, it would be desirable to have oil to the engine as early as possible, and use of the electric motor provides this benefit.

As shown schematically, an oil filter 34 is incorporated within the reservoir 24, and a passage 36 extends from the passage 26 upwardly into the reservoir 24. Similarly, passage 28 has a portion 38 extending upwardly into the reservoir 24.

The vessel 40 is preferably mounted in a housing 60, and is removable from the housing 60.

Preferably, the reservoir 24 and the filter 34 are removable as a modular unit, as is best understood from FIG. 2. As can be seen, an internal vessel 40 will be molded from plastic, and incorporates bosses 42 having a valve 44 spring biased by a spring 46 to a closed position. When the vessel 40 is inserted onto the portion 36 of the oil return line 26, pin 48 forces the valve 44 away from the boss 42. In this way, oil can move into the reservoir or vessel 40.

A similar boss 52 is closed by a valve 50 spring biased by a spring 53. Again, a pin 54 from an extension 38 of the oil supply line 28 opens the valve 50 when the vessel 40 is inserted onto the portions 36 and 38. However, when the vessel 40 is removed, the valves 44 and 50 move to close the bosses 42 and 52, thus capturing the internal oil. As shown, an oil filter 34 is preferably part of the vessel 40. Oil filter 34 is shown schematically, and could be any number of filter element types. Now, when it is desired to change the oil, the vessel 40 is merely removed. The oil will be captured by the valves 44 and 50, and thus the entire oil supply can be easily removed for changing. The use of the vessel 40 provides a much cleaner and simpler method of moving the oil to a recycle center.

A valve 56 is preferably also mounted into the portion 38. When the vessel 40 is removed, it is desirable to have a valve 56 preventing flow outwardly back through the opening of the portion 36.

A preferred embodiment of this invention has been disclosed, however, a worker in this art would recognize that certain modifications would come within the scope of this invention. For that reason, the following claims should be studied to determine the true scope and content of this invention.

1. An engine oil system comprising:
an engine having an oil drain line leading to an oil reservoir and an oil supply line leading to said engine from said oil reservoir, said oil reservoir being mounted remotely from said engine; and
said oil reservoir being removable from said return and supply lines and there being an oil filter being integrated within said oil reservoir and removable with said oil reservoir.

2. A system as recited in claim 1, wherein said inlet and outlet lines are associated with valves on said oil reservoir such that when said oil reservoir is removed said valves close said inlet and outlet lines preventing oil from leaving said oil reservoir.

3. A system as recited in claim 1, wherein an electric motor is mounted into said supply line.

4. A system as recited in claim 1, wherein said oil reservoir is a plastic housing member.

5. A system as recited in claim 1, wherein said oil reservoir is removable mounted in a base which surrounds said oil reservoir when said oil reservoir is mounted onto said lines.

6. A system as recited in claim 6, wherein a portion of said oil supply and oil return lines forces a valve upwardly away from a closed position in said oil reservoir to allow the oil to flow from said reservoir to said engine and from said engine back to said reservoir.

7. A removable oil reservoir for a dry sump system comprising:
a housing including an inlet and outlet opening, said inlet and outlet openings both being provided with a closure valve; and
a oil filter associated with said outlet line and incorporated into said reservoir housing.
